(19) United States
(12) Patent Application Publication
(10) Pub. No.: US 2019/0149420 A1
(43) Pub. Date: May 16, 2019

(54) SYSTEM AND METHOD FOR AUTOMATED SYSTEM MANAGEMENT

(71) Applicant: INTIGUA , INC., Newton, MA (US)

(72) Inventors: Tomer LEVY, Kfar-Saba (IL); Shimon HASON, Brookline, MA (US); Oran EPELBAUM, Givat Shmuel (IL); Shai TOREN, Alonei Aba (IL)

(73) Assignee: INTIGUA , INC., Newton, MA (US)

(21) Appl. No.: 16/246,574

(22) Filed: Jan. 14, 2019

Related U.S. Application Data
(63) Continuation of application No. 15/694,806, filed on Sep. 3, 2017, now abandoned.
Application No. 15/694,806 is a continuation of application No. 14/068,137, filed on Oct. 31, 2013, now abandoned.
(60) Provisional application No. 61/721,042, filed on Nov. 1, 2012.
(60) Provisional application No. 61/862,119, filed on Aug. 5, 2013.

(51) Int. Cl. H04L 12/24

(52) U.S. Cl. CPC H04L 41/0893

(57) ABSTRACT

A management unit comprising a processor, the management unit is configured to be in communication with at least one management system, the at least one management system configured to be in communication with at least one endpoint machine in an environment of multiple endpoint machines, the processor is configured to: assign for the at least one management system a dynamic group of endpoint machines; execute a relevant adaptor on the management system according to the assigned dynamic group; and apply to the dynamic group of endpoint machines, by the executed adaptor, policy rules relevant to the dynamic group of endpoint machines.

### CROSS-REFERENCE TO RELATED APPLICATIONS

This application is a Continuation Application of U.S. patent application Ser. No. 15/694,806, filed Sep. 3, 2017, which is a continuation of U.S. patent application Ser. No. 14/068,137, filed on Oct. 31, 2013 and which claims the benefit of U.S. Provisional Patent Application No. 61/721,042, filed on Nov. 1, 2012, and further claims the benefit of U.S. Provisional Patent Application No. 61/862,119, filed on Aug. 5, 2013, all of which are incorporated in their entirety herein by reference.

### BACKGROUND OF THE INVENTION

Cloud computing platform such as, for example, Amazon Web Services (AWS), Microsoft Azure, VMware vCloud and/or private cloud may provide simple on-demand services. However, these services may not comply with Service-Level Agreements, security and compliance policies of a corporate.

In order to provide a fully-functioning server in relatively short time, as often required from an Information Technology (IT) team in a corporation, all the critical management components such as, for example, monitoring, configuration management, inventory management, asset management, network management, security, logging and backup, may have to be managed manually, usually by an IT team in the corporation, which may be a silo within the corporation, because special expertise in the corporation's needs and policies is required. Therefore, it usually takes significant time and human resources to make the servers comply with all the management policies, and to continuously update, upgrade, reconfigure, reboot and verify proper operation of the settings on the server and/or the endpoints. Clearly, such model may be very limited and may not work properly in systems that include a very large number of instances, where instances are created and deleted on the fly in high rates.

In medium and larger enterprises a dedicated and specialized team focuses on each vertical of the System management. Usually, dedicated backup teams, Monitoring teams and security teams all work independently to provision, configure and decommission the relevant management piece for each server.

Provisioning a server also requires provisioning the management of that server. Provisioning a VM can take 10-15 minutes, but to integrate that server to all the Enterprise control and Management systems is cumbersome, manual, and error-prone. Different management configurations may need to be applied. For example, a certain server may have to be given a corresponding specific backup policy, a relevant monitoring configuration and relevant data loss prevention (DLP) and anti-virus (AV) tools.

There are methods to automate the infrastructure (compute, network and storage) layer by using virtualization. There are methods to automate application deployment layer by leveraging automation tools. However, the management of these systems is still manual and fragmented between multiple stakeholders. In some organizations, each newly provisioned endpoint (server/desktop) requires more than four role holders to make a change or configure a system. Most IT organizations are still stuck with manual change processes and the need for multiple teams of domain experts—each with its own specialized console—to provision and configure each management component, which can add weeks or even months to the time it takes to spin up a new server. All of these parameters make the automation of the system very ineffective and inefficient.

### SUMMARY OF EMBODIMENTS OF THE INVENTION

Embodiments of the present invention provides a system and method for automatic system management, the system comprising a management unit comprising a processor, the management unit is configured to be in communication with at least one management system, the at least one management system configured to be in communication with at least one endpoint machine in an environment of multiple endpoint machines, the processor is configured to: assign for the at least one management system a dynamic group of endpoint machines, execute a relevant adaptor on the management system according to the assigned dynamic group and apply to the dynamic group of endpoint machines, by the executed adaptor, policy rules relevant to the dynamic group of endpoint machines.

The processor according to embodiments of the present invention is further configured to connect to discovery sources in order to add and/or remove endpoint machines to dynamic groups and/or to enable communication between endpoint machines and management systems.

In some embodiments of the present invention, the endpoint machines are classified to dynamic groups according to classification attributes that indicate at least one of the role, functioning, relevance, grouping, attributes, metadata, time, location and status of the endpoint machines, wherein the processor is further configured to decide which management systems should be applied and how the applied management systems should be configured for each endpoint machine based on the classification.

The processor according to some embodiments of the present invention is further configured to detect that an endpoint was added to a dynamic group and apply to the added endpoint machine the policy rules relevant to the dynamic group of endpoint machines, and wherein the processor is further configured to detect that an endpoint was removed from a dynamic group and cease applying to the removed endpoint machine the policy rules relevant to the dynamic group of endpoint machines.

The processor according to some embodiments of the present invention is further configured to monitor a configuration of an endpoint machine to verify that the correct policy rules are applied and change the configuration of the endpoint machine in case a configuration of the endpoint machine is not correct according to the relevant policy.

The processor according to some embodiments of the present invention is further configured to execute policy rules, wherein a rule includes indication of to which dynamic group of endpoint machines the rule applies, the actions that should be taken when the rule applies and metadata about the rule.

The processor according to some embodiments of the present invention is further configured to execute by the adaptor at least one function of a list comprising: connecting to the management system, registering an endpoint machine to a management system, assigning a relevant configuration to a management system, configure the communication channel between management system and endpoint, create a proxy channel between management system and endpoint, establish the identity of management system and endpoint machine, assigning a relevant configuration to an endpoint machine, querying whether a current configuration of an endpoint machine is correct, querying the health of the management system, querying the health of an endpoint and deregistration of an endpoint machine from the management system.

The processor according to some embodiments of the present invention is further configured to build policy rules and/or improve existing rules based on information and analysis about machines, servers, tools, configurations and operations gathered from at least one of a list comprising endpoint machines, management systems, storage systems, processor operations and network devices or operations.

The processor according to some embodiments of the present invention is further configured to queue all the endpoint machines assigned to the management system and execute a query on each of the queued endpoint machines, according to the queue, whether a current configuration of the endpoint machine and/or of a related management system is correct.

The processor according to some embodiments of the present invention is further configured to perform at least some of the operations by at least one virtual agent applied to at least one endpoint machine, wherein the processor is further configured to perform at least one of a list comprising: deploying a virtual agent to an endpoint machine, replacing an old virtual agent with a new virtual agent, changing configuration of a virtual agent, removing a virtual agent, validating connectivity of a virtual agent to the relevant management system, control resource consumption of a virtual agent, validation of general health and/or functionality of a virtual agent and validation of configuration of a virtual agent according to the correct policy rules.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a schematic illustration of a system for automatic system management according to embodiments of the present invention;

FIG. 2 is a schematic illustration of a management unit and its main modules and interfaces, according to embodiments of the present invention; and

FIG. 3 is a schematic flowchart illustrating a method for automated system management according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention may provide a system and method for cloud and/or internal system management, which automates change processes in the system. Thus provision and configuration of a new server, as well as monitoring, upgrading and updating of the servers in the system may all be automated and preformed continuously.

Once endpoints and/or servers are provisioned and configured, they can move from an internal datacenter to a cloud, between clouds or between roles. This can entail a different management policy for them. The system and method according to embodiments of the present invention may provide the management configuration when the endpoint or server is created, maintain, change or update the management configuration of each endpoint or server and control the management of the endpoint or server through all changes. For example, according to embodiments of the present invention, when an endpoint or server is moved from one cloud to another, from one physical location to another, from one datacenter to another or from one host to another etc., the change may automatically be detected and a different configuration and/or a new management policy may automatically be applied to the endpoint or server.

Embodiments of the present invention may provide a platform for centralized, policy-driven provisioning, configuration and ongoing management of a portion of or an entire management stack of servers and endpoints of a corporation.

Embodiments of the present invention may provide a system and method for management of a system such as, for example, datacenter, private, hybrid or public cloud, in an environment of virtual and physical machines, desktops or servers or mobile devices, by virtualized management agents. Original management agents such as for monitoring, backup, performance, antivirus, compliance, automation, security, configuration, and/or other agents may be virtualized and/or run virtually on machines, for example remote machines, for example machines that may be included in datacenters environment. A system according to embodiments of the present invention may control a virtual infrastructure of virtual agents that may run virtually on machines in the datacenters environment. The execution of the virtual agents may be done based on pre-defined policies. Embodiments of the present invention may provide system management based on virtual agents without the requirement to install and configure agents on each machine. This may save, for example, time and operational overhead costs so as shortening time to market, improve and protect application performance and uptime, reduce risks associated with making changes and ensure and simplify compliance.

Management system 160 may include several back-end servers and/or tools such as monitoring, backup, configuration management, network management, storage management, security management, anti-virus, anti-malware, Data leakage prevention, host intrusion prevention system, asset management, inventory management, cloud management, application performance management. For example tools from HP, CA, BMC, IBM, VMware, Microsoft, Oracle, EMC, Netapp, Cisco, Check Point, Juniper, Google, Chef, Puppet Labs, AWS and others.

An endpoint machine may be running on any available Operating System, for example: Windows® 2000, Windows® 2003, Windows® 2008, Windows® 2012, Linux® from multiple distributions, Unix®, HP-UX®, Android, Solaris, AIX® etc. These Operating Systems may be of 16 bit architecture, 32 bit architecture and 64 bit architecture.

Additionally, a system and method according to embodiments of the present invention may monitor, for example continuously, activity of virtual agents. Embodiments of the present invention may enable controlling of consumption of resources across the infrastructure of virtual agents and thus, for example, enable optimization of application performance.

Additionally, a system an method according to embodiments of the present invention may leverage physical agents (non-virtual agents).

In some embodiments of the present invention, tracking and/or management of the entire virtual and/or physical management infrastructure may be performed from one central console.

Although a virtual agent as described herein may function and behave as if it was installed on each machine, the operation or execution of a virtual agent may be decoupled from the underlying operating system. Otherwise described, an agent may be executed on a machine (physical or virtual machine) without being installed on the machine as done in prior art systems and methods.

Virtually executing virtual agents instead of installing agent software on thousands of machines may drastically cut down agent management overhead. For example, agent upgrade processes may include a simple replacing of a file on the endpoint machine and/or may be performed, according to embodiments of the invention, for example, with a mouse click or other command/input by an input device from a user. Other operations, e.g., rebooting, scripting, logging on and off servers, coordinating change management windows, testing for agent conflicts and manual installations when scripting tools fail may all be avoided using embodiments of the invention. In an embodiment, user defined policies may control virtual agents operation or deployment, e.g., in order to proactively optimize application performance and avoid agent storms.

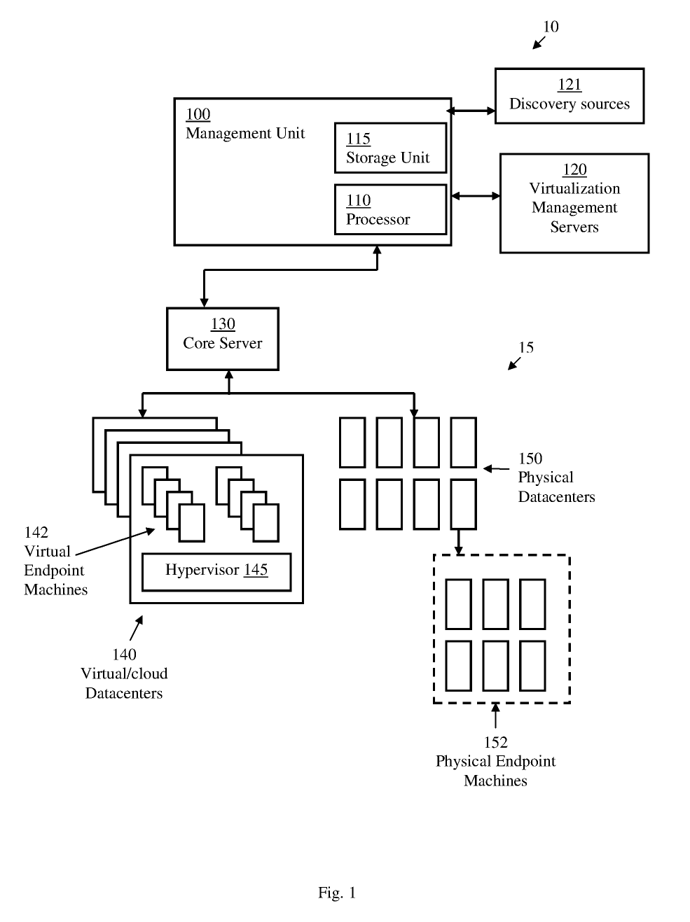

Reference is now made to FIG. 1, which is a schematic illustration of a system 10 for automatic system management according to embodiments of the present invention. System 10 may manage datacenters/servers 140 and 150 in an environment 15 of virtual and physical datacenters/servers 140 and 150. Datacenters/servers 140 and 150 may include/be in communication with virtual endpoint machines 142 and physical endpoint machines 152, respectively, that may be managed by virtual agents, for example as describe in detail in U.S. patent application Ser. No. 13/572,740, titled SYSTEM AND METHODS FOR MANAGEMENT VIRTUALIZATION, incorporated herein by reference. A datacenter may be called a datacenter server or datacenter/server interchangeably throughout the present description. As discussed in detail below, embodiments of the present invention may enable execution of virtual agents at endpoint machines by containers such as, for example, package files that include the virtual agents, without a requirement to install the virtual agents in the endpoint machines. System 10 may include a management unit 100, virtualization management servers 120, discovery sources 121 and core servers 130. A container may include a plurality of virtual agents, and the plurality of virtual agents may be executed within a single container file, on the endpoint machine.

Management unit 100 may include a processor 110 and storage unit/medium 115, and may manage/control virtualization management server 120 and discovery sources 121 and the virtual environment including infrastructure of virtual agents and/or virtual machines, for example endpoint machines. Management unit 100 may store images of the virtual agents, policies to control the virtual agents, data about the virtual infrastructure of virtual agents and/or virtual machines, data about the physical machines and infrastructure of environment 15 and/or any other data that may be required, for example in order to manage the virtual infrastructure of virtual agents. In some embodiments, a virtual agent may be automatically joined to the managed environment upon executing the virtual agent on the endpoint machine and automatically disjoining the virtual agent from the managed environment upon removing the endpoint machine from an installation in environment 15.

Management unit and/or Processor 110 may control, manage and/or be in communication with core servers 130 and datacenters/servers 140 and 150. Management unit and/or Processor 110 may control and manage system 10. Embodiments of the invention may include an article such as a computer or processor readable non-transitory storage medium, for example storage medium 115, such as, for example a memory, a disk drive, or a USB flash memory encoding, including or storing instructions, e.g., computer-executable instructions, which when executed by a processor or controller 110, cause the processor or controller 110 to carry out methods disclosed herein. Processor 110 may control management unit 100 and other units and modules of system 10 to perform the steps and/or functions described herein and to carry out methods disclosed herein.

Management unit 100 may enable a user to create a library of virtual agents. Management unit 100 may convert original agent installers, which may be uploaded to management unit 100 by a user, into virtual agents. The virtual agents may be stored, for example, in a designated storage library in management unit 100. As described in more detail below, the virtual agents may be encapsulated in a virtual agent container (may also be called package), which may include in addition to the virtual agent a configuration for execution of the virtual agent at the endpoint machine, for example without installing the virtual agent in the endpoint machine. A virtual agent container file may include and/or wrap one or more virtual agents, for example multiple virtual agents and their configurations.

Virtualization management servers 120 may include any third-party software for management of virtual machines. Any number of virtualization management servers 120 may be included in system 10 and the invention is not limited in this respect.

Discovery source 121 may include any third party software to provide information about physical, virtual or cloud machines (desktops and servers). Any number of discovery sources 121 may be included in system 10 and the invention is not limited in this respect. Discovery sources can be for example, middleware service like Amazon AWS, Microsoft Azure, VMware Hybrid Cloud, Active Directory, CMDB service, proprietary list of machines etc′.

Core servers 130 may each be in communication with multiple endpoint machines 142 and 152. Core servers 130 may push the virtual agent container file to relevant endpoint machines, for example upon a command received from a user or the policy engine. Upon such command, management unit 100 may share container files with core servers 130, which may push the container files to relevant endpoint machines. Virtual datacenters 140 may be, for example cloud data centers. Cloud data centers 140 may be managed by hypervisors 145. Communication between core servers 130 and virtual endpoint machines 142 may be facilitated through hypervisor 145, for example without the need for direct network connectivity between core servers 130 and endpoint virtual machines 142. Physical endpoint machines and virtual endpoints 142 may communicate with core servers 130 by standard network connections. Any number of core servers 130 and any number of datacenters 140 and 150 may be included and the invention is not limited in this respect. Each core server 130 may support thousands of virtual agents. Each management unit 100 may support and/or manage a number of core servers 130 according to the number of virtual agents in the datacenters environment.

Core servers 130 may further enable controlling the virtual agents executed at the endpoint machines inside the container, e.g. not installed on the operating system. The execution of the virtual agents at the endpoint machines inside the container may be decoupled from the operating system of the endpoint machine such as, for example, the management, virtual deployment, upgrades, downgrades, troubleshooting and termination of the virtual agents may be performed in the container independently from the operating system. Components of the container may monitor processes performed by a virtual agent, detect failures, health problems, misconfigurations, illegal access, tempering attempts and/or remedy failures in the operation of the virtual agent, for example in real time. Additionally, components of the container may communicate with hypervisor 145 and/or coordinate operations with operations performed by other virtual agents, for example in other virtual endpoint machine supervised by the same hypervisor 145. The coordination may resolve and/or prevent performance bottlenecks. Management actions performed by modules/components of the container may be executed based on policies stored in the container and/or in management unit 100, which may be predefined or defined during operation, for example by a user. By decoupling execution of agents from the operating system in the described manners, users may save time and risk of agent deployments, upgrades and troubleshooting.

Environment 15 of virtual and physical datacenters 140 and 150 may belong and/or be controlled by a corporation with certain policies, management system 160 and/or tools that are being used and security requirements. A virtual or physical endpoint machine 142 or 152 may be a virtual or physical server or a virtual or physical desktop or a mobile device, for example having a certain function, or a personal endpoint virtual or physical machine, or any other virtual or physical computer machine, for example belonging and/or controlled by the corporation.

An endpoint machine 142 and/or 152 may change its location, role and/or function, and/or may be moved from one server, datacenter server or cloud server to another server, datacenter server or cloud server, and/or its environment or status may otherwise be changed, and/or it may require updates and/or upgrades for tools installed thereon. The status of an endpoint machine, or such changes in status and/or requirements, may be automatically detected by a virtual agent stored in a container installed on an endpoint machine 142 or 152, and/or by periodic requests sent from management unit 100 to the endpoint machine and vice versa, and/or by gather information from virtualization management 120 and/or discovery sources 121, and/or by detecting network, storage, time and/or state information for example via the core server 130. Some or all of endpoint machines 142 and/or 152 may have virtual and/or actual software agents installed thereon. However, the present invention is not limited in that respect. In some other embodiments, the automatic detection may be performed by a sensor/plug-in installed on the endpoint machine and/or on the datacenter server or cloud server, which may send data to management unit 100, for example via core server 130.

For example, management unit 100 may detect, for example, that an endpoint was added or removed, changed status and/or group, and/or suffered an error. For example, the endpoint machine may be classified by a custom, dynamic definition that may be recognizable by management unit 100. The definition may be informative regarding the machine's status such as, for example, role, functioning, location, time, machine metadata, relevance, grouping, and/or any other suitable status parameter. Based on the definition, or when the definition changes, management unit 100 may detect a status or a change in status of the machine. For example, the endpoint machines in environment 15 may be classified to multiple dynamic groups, wherein each endpoint machine may belong to at least one of the dynamic groups of machines, classified according to attributes such as, for example, name, IP mask, IP space, hostname, any kind of identification, any kind of address, zone, tag, directory, or any custom attribute assigned to a machine and/or a group of machines by a user or controller. The machine classification to groups may be expressed in the recognizable custom, dynamic definition. The classification attributes, according to which the endpoint machines are classified to the dynamic groups, may be related to and/or indicate the role, functioning, relevance, grouping, and/or any other suitable status parameter of the endpoint machines. According to the classification, management unit 100 may decide which management system 160 should be used and/or applied to a specific endpoint machine.

Based on a detected status or change, management unit 100 may implement and/or enforce rules on how the endpoint machine should be managed, for example according to a corporation policy. For example, management unit 100 may decide which management system 160 should be used on the specific endpoint machine, how a management system 160 applied on the endpoint machine should be configured, and/or may decide to make changes in the endpoint machine, for example by utilization of virtual agents, which may make changes without risking the functioning of the endpoint machine.

Additionally, management unit 100 may continuously monitor environment 15, datacenters 140 and 150 and endpoints 142 and 152. For example, management unit 100 may send an inquiry to an endpoint machine, for example to a virtual/software agent or a plug-in applied on the endpoint machine, to validate that the endpoint machine is configured according to the correct policy. In case the configuration of an endpoint machine or of a management system 160 and/or tool applied to the machine is not a suitable configuration according to the correct policy, for example if the configuration does not match the correct policy, a policy drift is detected. Management unit 100 may automatically fix a policy drift, by sending a command to the agent/plug-in to change the configuration according to the correct policy. Management unit 100 may automatically fix a policy drift, by sending a command to the management system 160 to change the configuration according to the correct policy Similarly, management unit 100 may monitor health of elements in environment 15, such as verification that products and/or tools applied to endpoint machines are healthy and functional, and may verify that core server 130 and/or datacenters servers 140 and 150 run and configured properly and may verify that endpoint machines are healthy and running properly.

In case changes in environment 15 are detected by management unit 100, management unit 100 may re-match policies to the changed endpoint machines. For example, in case an endpoint machine changed its role/function, the relevant policy may be applied to the endpoint machine, for example instead of a previous policy. Additionally, relevant management systems 160 and/or toolsmay be applied to the machine and configured according to a relevant policy, according to the new role/function of the endpoint machine, and/or other tools may be removed or reconfigured according to the relevant policy. For example, the change in role may be detected by identifying a change in the detectable classification definition of the endpoint machine.

In case the policy itself changes, with or without changes in environment 15, management unit 100 may apply the policy change to the relevant endpoint machines and/or relevant management systems and/or back-end tools 160 applied to the relevant endpoint machines. For example, management unit 100 may change configurations of endpoint machines and/or applied back-end tools 160, and/or may remove and/or apply relevant management systems and/or back-end tools 160 on the relevant endpoint machines, with the correct configurations according to the new policy. Additionally, for example, based on a new policy, applied agents and/or plug-ins may be removed from endpoint machines and/or replaced with updated agents/plug-ins.

In case an endpoint machine is detected by management unit 100 to be unhealthy, for example in functioning, management unit 100 may automatically apply a remediation policy.

Management unit 100 may apply a relevant configuration for certain management systems 160. For example, a certain agent on an endpoint machine may be controlled by a commands and/or requests received from a management systems 160, i.e. a certain server controlling this product and/or endpoint machine, such as a datacenter 150 or cloud server 140, or core server 130. For example, when a new endpoint is configured, or an old configuration is changed, sometimes the endpoint needs to be registered to a management system 160. Management unit 100 may apply configurations to the management systems 160 server as well as to the endpoint machine, for example, configuring the back-end server to apply a backup process in certain predetermined periods to a tool applied on the endpoint machine. Generally, management unit 100 may apply management configurations to the back-end server, such as how to handle certain situations in the endpoint machine. For example, management unit 100 may apply a management configuration to the management systems 160, saying how an agent and/or virtual agent applied to the endpoint machine should be handled in all sorts of situations, for example in case the agent does not work properly or utilizes too many CPU resources.

In some embodiments of the present invention, a certain dynamic group of machines may be managed by a corresponding management system 160. A dynamic group of endpoint machines may be identified by a certain policy identifier, which may instruct the corresponding management system to apply a certain policy to the endpoint machines in that group. The management system may include or may be assigned with an adaptor, for example configured by management unit 100, which may configure the management system to control and manage this group by assigning to this server the certain policy identifier and may assign the relevant endpoint machines to this management server, based on this policy identifier. In some embodiments, a product/tool applied in an endpoint machine may include a virtual agent which may be applied to the endpoint machine. Such virtual agent may include an “install” configuration. For example, once a virtual agent is applied to/installed on an endpoint machine, it may configure a corresponding management system addresses, ports and/or any other parameter which may enable assigning of the endpoint machine to the relevant management system. Once installed, the virtual agent may report the status, configuration, functioning, actions and/or other parameters of the to the management system. The virtual agent may also apply the policy identifier to the endpoint machine, thus assigning the endpoint machine to the corresponding back-end server.

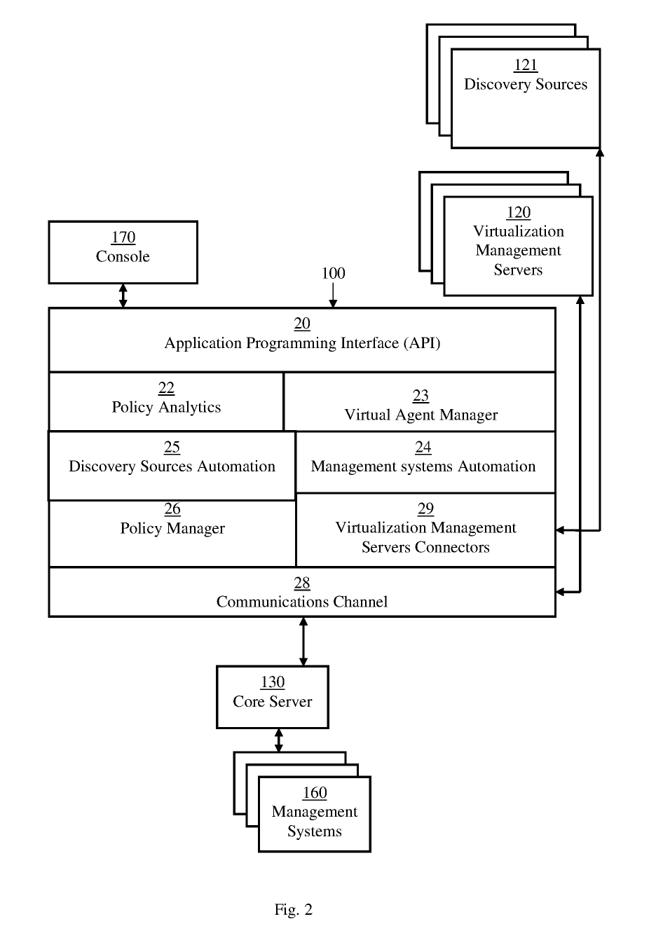

Reference is now made to FIG. 2, which is a schematic illustration of management unit 100 and its main modules and interfaces, according to embodiments of the present invention. Management unit 100 may include, for example, an Application Programming Interface (API) 20, a policy analytics module 22, a back-end server automation module 24, a policy management module 26, a communications channel 28 and virtualization management connectors 29. API 20, policy analytics module 22, management system automation module 24, policy management module 26, communications channel 28 and virtualization management connectors 29 and/or any other module and/or interface of management unit 100 may be included, controlled and/or executed by processor 110 shown and described with reference to FIG. 1. Management unit 100 may also include and/or interface with console 170, by which a user may monitor and manage management unit 100 and system 10. Console 170 may include a graphical user interface that may communicate with management unit 100 via API 20, by which a user may view, monitor and manage management unit 100 and system 10.

API 20 may include, for example a Representational State Transfer (REST) API or any other suitable API, which may provide a standard and easily integrated interface between management unit 100 and other, for example, higher level, automation, orchestration and/or virtualization systems.

Management unit 100 may act as a central management server for deployment, configuration, auditing and/or performing any other suitable operation for supervision and/or execution of virtual management agents across the datacenters supervised by management unit 100. Management unit 100 may constitute a management center for management of multiple virtualization management servers 120, multiple discovery sources 121 and multiple physical and virtual datacenters. Virtualization management connectors 29 may include a plug-in mechanism to integrate with virtualization management servers 120, which may include, for example, third party virtualization management servers, such as, for example, public and/or private cloud servers, such as, for example, Amazon® web services (AWS), Microsoft® Azure, VMware vCenter®, Microsoft® Hyper-V Management™ Server, Oracle® Virtualization, Citrix® Xen, KVM, Virtual Box, Parallels, Linux Containers, Linux zones, Red Hat® Enterprise Virtualization and/or any other suitable virtualization management servers. Communications with management system 160 may be performed via communications channel 28.

Discovery sources automation 25 module may plug-in or otherwise connect to one or more discovery sources 121. By the plug-in and/or connection, management unit 100 may read the list of endpoint machines, their current status, power status, location and other metadata. Additionally, by the plug-in and/or connection, management unit 100 may interact with routing and/or firmware platforms, for example in order to automatically open relevant routing holes and/or paths, so that communication between endpoint machines and back-end servers and/or management systems may be enabled. Therefore, by the plug-in and/or connection, management unit 100 may read data regarding virtual/cloud server instances and/or register new server instances to management unit 100 and/or remove decommissioned instances. Additionally, by the plug-in and/or connection, management unit 100 may read tags defined on instances of the virtual/cloud servers and/or provide the information in the defined tags to a user via console 170.

Virtualization management connectors 29 may plug-in or otherwise connect to a virtualization management server 120. By the plug-in and/or connection, management unit 100 may read the list of endpoint machines, their current status, power status, location and other metadata. Additionally, by the plug-in and/or connection, management unit 100 may interact with routing and/or firmware platforms of the virtualization management servers 120, for example in order to automatically open relevant routing holes and/or paths, so that communication between endpoint machines and back-end servers may be enabled. Therefore, by the plug-in and/or connection, management unit 100 may read data regarding virtual/cloud server instances and/or register new server instances to management unit 100 and/or remove decommissioned instances. Additionally, by the plug-in and/or connection, management unit 100 may read tags defined on instances of the virtual/cloud servers and/or provide the information in the defined tags to a user via console 170.

A user may log in to management unit 100 via a web browser, and then the user may configure and monitor system 10 by the graphical user interface on console 170. Once a user applies settings and configurations to system 10, the management unit 100 may process the settings and configurations and send the relevant commands to management systems 160. management systems 160 may interact, via a hypervisor or directly, with virtual and/or physical endpoint machines to apply the settings and commands. Via console 170, a user may apply settings and configurations to specific servers, datacenters or machines, or may apply a policy, e.g. a set of automatic rules for setting and/or configuring a group of servers, datacenters or machines. For example, a user may determine which management systems should be used for each endpoint, how these management systems should be configured and implement that configuration on each management system 160. For example, For example, a user may determine which virtual agents should be applied to which servers, datacenters or machines. For example, a user may determine management policies for cases of virtual agent failure of an operating system failure. For example, a user may determine performance requirements such as memory, computing power and/or bandwidth consumption and/or any other suitable performance requirements for virtual agents.

Policy manager 26 may be configured by the user with the relevant management policies. Policy manager 26 compiles the management policies and may apply corresponding tasks to the relevant management systems 160, which may apply the tasks on the relevant endpoint machines. Management unit 100 may be automated by developing and integrating software into management unit 100. In some embodiments, a user may fully or partially automate management unit 100, for example by a software development kit (SDK) that may be included in management unit 100. Policies applied by a user and/or by policy manager 26 may include, for example, management system configuration, networking configuration, security configuration, deployment policies for deployment of virtual agents and/or non-virtual agents, performance protection policies and proactive management policies.

Policy manager 26 manages the list of rules that together are consider the policies. In some embodiments, a built rule includes three basic sections: matching section, action section, and metadata section. The matching section of a rule built by policy manager 26 may include indication of to which endpoint machines the rule applies. The indication may be performed by the dynamic groups described herein, e.g. the matching section may indicate the dynamic group or groups to which the rule is applicable. The action section may describe the actions that should be taken when and where the rule applies. For example, the actions may include deployment of a management package, the package describing, for example, the configuration and/or implementation of a management system being used for managing, securing and/or configuring an endpoint machine. Additionally or alternatively, for example, the actions may include recommendation to deploy such or another management package. Additionally or alternatively, the action may include settings and configuration of the endpoint operating system, services, daemons, processes, registry and file system. The metadata section may include metadata about the applicable rule. Such metadata may include a serial number of a rule, identification of a creator of the rule, time of creation of the rule, rule's source, and comments about the rule, rule group attribution, and/or any other suitable metadata about the rule.

Policy manager 26 and policy analytics 22 may be configured to learn and build policy rules independently, on the fly, according actual configuration, existing configuration of management system, type of agents installed, management systems applied, endpoint machines and/or tools and/or products installed on endpoint machines. Policy analytics 22 incudes a data collection component that collects that data and build suggested rules based on that actual or existing configuration. The policy analytics may configure rules in the policy manager 26. The policy analytics may also export the suggested rules to the console 170 to get further confirmation or instructions from the user.

Policy manager 26 may execute and/or control execution of the created rules. In some embodiments, policy manager 26 may indicate an order for execution of the rules. In some embodiments, the rules may be executed by policy manager 26 or policy manager 26 may control execution of the rules by serial order, for example according to the serial number of the rule indicated in the metadata, for example one rule after the other, by order of the serial numbers. When a rule is found to be applicable for a certain dynamic group of end-points, the action section of a rule may be executed, for example by applying a management package as described herein or by sending and/or displaying a message that a certain management package should be applied to a certain endpoint machine or a group of endpoint machines. The metadata information included in the metadata section may be stored, for example once a rule is executed, in policy analytics module 22.

Additionally, policy manager 26 may include a policy verification mechanism that may verify that the policy and/or rules execution works properly, may detect conflicts in the policy and/or may alert against such conflicts that may occur. In some embodiments of the present invention, for example, when two or more rules contradict each other, execution of all or some of the contradicting rules may be skipped. For example, a contradiction may occur when two different rules have management packages deployable on the same product/tool, for example because two different back-end configurations are applied on the same tool, for example by two versions of the same agent applied on the endpoint machine.

Back-end server automation module 24 may be an open adaptor based platform for configuration, control and monitoring of any software, tool and/or product installed on an endpoint machine. Server automation module 24 may, for example, automatically configure management systems applied to an endpoint machine. Particularly, some events in a lifecycle of an endpoint machine may require such automatic configuration, as described in detail herein. Server automation module 24 may execute adaptors on the management systems, the adaptors include the management packages and configuration rules gathered from the policy manager. Each adaptor may be executed on the respective management system or remotely by the server automation module 24. The adaptors may include the knowledge how to monitor and configure a management system. By the adaptors, server automation module 24 may provide automatic handling of logging issues, debugging and errors. The adaptors may be custom made, for example for a particular software, product or tool installed on an endpoint machine.

Management System automation module 24 may communicate with the adaptors executed on each of the back-end servers. The adaptors may have several functions that may enable server automation module 24 automation of the back-end server. For example, an adaptor may execute connection of server automation module 24 to the management system to which the adaptor is related. The connection may be triggered by the management system automation module 24. For example, an adaptor may execute registration of an endpoint machine to a management system for example according to the policy identifier and/or by a virtual agent as described above. For example, an adaptor may execute assigning of a relevant configuration and/or policy to an endpoint machine, according to the rules decided by policy manager 26 as described in detail herein. For example, an adaptor may execute a query whether a current configuration of an endpoint machine is correct and/or functions properly. For example, an adaptor may execute deregistration of an endpoint machine from the back-end server, for example in case the endpoint machine does not belong to a relevant dynamic group anymore.

Management system automation module 24 may continuously query and/or receive indications, for example, via the adaptors, about whether an endpoint is configured properly and/or according to the correct policy rules decided and/or built by policy manager 26. For example, for a certain management system, automation module 24, by the adaptor, may queue all the endpoint machines assigned to this server, and execute a query on each of the queued endpoint machine, according to the queue, whether a current configuration of the endpoint machine is correct and/or functions properly.

Policy analytics module 22 may aggregate the events of rules execution and/or may generate statistics and/or conclusions about the functioning of policy manager 26, possible problems and/or trends in the rules and/or any other possible statistics and/or conclusions about policy manager 26 and the executed rules.

Policy analytics module 22 may store data about servers, datacenters and/or endpoint machines, data about virtual agent container, associations between servers, datacenters and/or endpoint machines and virtual agent container and management policies data. In addition, policy analytics module 22 may store events and logs generated by endpoint machines. Policy analytics module 22 may include a relational database to relate data about endpoint machines with data about virtual agents. Data about endpoint machines may include name, Internet Protocol (IP) address, operating system in use, and/or any additional suitable data. Policy analytics module 22 may also collect and/or store events and logs from endpoint machines, process the events and logs and generate reports, for example upon a user's request or periodically. The generated reports may be in a fully searchable format.

For example, policy analytics module 22 may generate rules based on the collected dat.

For example, policy analytics module 22 may generate audit reports, reports about endpoint machines, excessive resource consumption events, virtual agent predicted performance and/or any other report based on data collected and/or stored in policy analytics module 22. Audit reports generated by policy analytics module 22 may include logs of changes in the managed environment, including the time and user identification. Reports about endpoint machines may present endpoint machines in the managed environment that are managed or not managed by management unit 100. In some embodiments, any endpoint machine in the environment may be automatically controlled and/or manageable by management unit 100. In some embodiments, an endpoint machine in the managed environment may be unmanageable by management unit 100 because of a problem, error or failure that may be solved by a troubleshooting policy or by a user through console 170. Reports about endpoint machine may enable a user to identify such problems and solve them. Reports about excessive resource consumption events may constitute an events log and/or present, for example, events that triggered excessive resource consumption by virtual agents. The report may also present data about initiated proactive actions for moderating these events, for example by management unit 100. Reports about virtual agent predicted performance may predict resource consumption by virtual agents before pushing virtual agents to endpoint machines. For example, management unit 100 may detect that a particular virtual agent will consume a lot of memory. As a result, management unit 100 and/or the user may compute that a certain number and/or percentage of machines may experience memory shortage.

In some embodiments of the present invention, management unit 100 may include a virtual agent management module 23 for distribution and management of virtual agents. Virtual agent management module 23 may deploy a virtual agent to an endpoint machine, replace an old virtual agent with a new virtual agent, change configuration of a virtual agent or remove a virtual agent, for example, when a management package includes a certain virtual agent that have to be implemented on the endpoint machine. Additionally, virtual agent management module 23 may monitor the health of the virtual agents, for example by execution of periodic health monitor scripts, command lines and/or any other suitable manner of health validation. For example, health validation may be executed periodically, for example in each container of a virtual agent. Health validation may include validation of connectivity to the relevant back-end server, validation of normal resource consumption, validation of general health and/or functionality, validation of configuration according to the correct policy rules, and/or any other suitable validation of proper status and/or functioning.

As discussed above, system 10 and the virtual agents may be monitored and managed through console 170, including a dashboard and/or a graphical user interface. Console 170 may display data about managed endpoint machines, virtual agents that are running on the endpoint machines and proactive management policies, which are applied to each machine. Console 170 may enable a user to create and embed in management unit 100 management and performance policies for the virtual agents. In some embodiments of the present invention, viewing, controlling, managing and/or any other kind of accessing into a virtual agent may be performed, for example, exclusively, by a user identified as an owner and/or any kind of administrator of the virtual agent.

Management unit 100 may detect all the machines across the data centers 140 and 150 in environment 15. Management unit 100 may collect and store in policy analytics module 22 real-time information about statuses of endpoint machines, operating system used on each machine, virtual agents running on each machine, versions of virtual agents, and any other suitable data required for managing system 10 and the virtual agents.

In order to deploy virtual agents to endpoint machines, a user can select a virtual agent and push it to substantially any number of selected endpoint machines by commands via console 170. The virtual agent may then be executed on the selected machines as described herein and deliver all the functionality of the original agent, without actually being installed on the endpoint machine and without incurring excessive costs and waste of time associated with mass agent deployments on each machine separately. Additionally, via console 170, a user may schedule in advance specific time slots for virtual agents to be pushed to their endpoint machine automatically.

Additionally, via console 170, user can define the setup of rules compromising a policy. Each rule may include the three key objects: match, which means to which endpoint it should be applied to, action which describes what should be done as part of this rule and the metadata for that rule.

For virtual datacenters 140, pushing of virtual agents by management systems 160 to endpoint machines may be performed whether the virtual endpoint machine is powered on or powered off. In case the virtual endpoint machine is powered off during the pushing of the virtual agent, the virtual agent is already included and may be executed in the endpoint machine once the machine is powered on. Additionally, in case virtual endpoint machine is power off, virtual agent management module 23 can access the storage directly to alter the file system and apply the virtual agent even when the endpoint machine is powered off.

In order to upgrade a version of a virtual agent a user may upload the selected version of the original agent installer files to management unit 100, which, as described above, may convert the original agent installer files to a virtual agent and may distribute the virtual file to core managers 130. Then, core manager 130 may push the virtual agent to all the relevant endpoint machines. The pushing may be done upon a command form a user via console 170. Reverting back to a previous version may be done in a similar manner.

Console 170 may display virtual agents applied to endpoint machines and non-virtual agents installed on the same endpoint machines. When a virtual agent is applied to an endpoint machine, the installed agent may be deactivated. The virtual agent container may copy configurations from the installed agent to the container and/or the virtual agent may be executed with configurations of the installed agents. The non-virtual installed agent may not be removed from the machine and may be reactivated if desired. This side by side architecture of virtual and non-virtual agents may allow users to implement the use of system 10 gradually and with minimal risk.

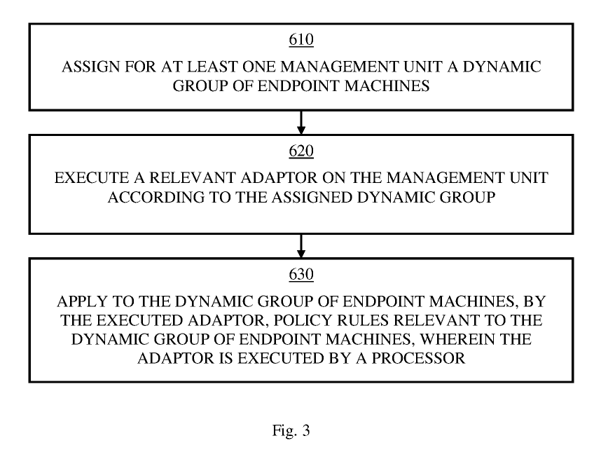

Reference is now made to FIG. 3, which is a schematic flowchart illustrating a method for automated system management according to embodiments of the present invention. As indicated in block 610, the method may include assigning for at least one management system a dynamic group of endpoint machines, for example according to embodiments of the present invention as described in detail herein. As indicated in block 620, the method may include executing a relevant adaptor on said management system according to the assigned dynamic group, for example according to embodiments of the present invention as described in detail herein. As indicated in block 630, the method may include applying to said dynamic group of endpoint machines, by said executed adaptor, policy rules relevant to said dynamic group of endpoint machines, wherein said adaptor is executed by a processor, for example according to embodiments of the present invention as described in detail herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. For example, some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system comprising:
a management unit comprising a processor, the management unit being configured to be in communication with a set of management systems, the set of management systems adapted to manage a set of endpoint machines, the processor being configured to:
classify one or more of the endpoint machines to one or more dynamic groups according to classification attributes of the endpoint machines;
assign at least one of the dynamic group to at least one of the management systems;
send a management configuration to the at least one management system, wherein the at least one management system is adapted manage endpoint machines included in a dynamic group based on the management configuration;
automatically detect that an endpoint machine was added to a network;
decide, according to a classification of the endpoint machine, which management system should be used for managing the endpoint machine; and
add the endpoint machine to a dynamic group managed by the management system, wherein the management system is adapted to interact with the endpoint machine and to apply, to the endpoint machine, settings according to the management configuration.

2. The system according to claim 1, wherein said processor is further configured to do at least one of: remove an endpoint machine from a dynamic group and enable communication between endpoint machines and management systems.

3. The system according to claim 1, wherein the endpoint machines are classified to dynamic groups according to classification attributes that indicate at least one of the role, functioning, relevance, grouping, attributes, metadata, time, location and status of the endpoint machines, wherein said processor is further configured to decide which management systems should be applied and how the applied management systems should be configured for each endpoint machine based on the classification.

4. The system according to claim 1, wherein said processor is further configured to detect that an endpoint was added to dynamic group and apply to said added endpoint machine a rule related to said dynamic group of endpoint machines, and wherein said processor is further configured to detect that an endpoint was removed from a dynamic group and cease applying the rule to said removed endpoint machine.

5. The system according to claim 1, wherein said processor is further configured to:
monitor a configuration of an endpoint machine to verify that the correct rules are applied; and
change the configuration of the endpoint machine in case a configuration of the endpoint machine is not correct according to the relevant rules.

6. The system according to claim 1, wherein said processor is further configured to execute rules, wherein a rule includes indication of to which dynamic group of endpoint machines the rule applies, the actions that should be taken when the rule applies and metadata about the rule.

7. The system according to claim 1, wherein said processor is further configured to execute by the adaptor at least one function of a list comprising: connecting to the management system, registering an endpoint machine to a management system, assigning a configuration to a management system, configure the communication channel between management system and endpoint, create a proxy channel between management system and endpoint, establish the identity of management system and endpoint machine, assigning a configuration to an endpoint machine, querying whether a current configuration of an endpoint machine is correct, querying the health of the management system, querying the health of an endpoint and deregistration of an endpoint machine from the management system.

8. The system according to claim 1, wherein said processor is further configured to build rules and to improve existing rules based on information and analysis about machines, servers, tools, configurations and operations gathered from at least one of a list comprising: endpoint machines, management systems, storage systems, processor operations and network devices or operations.

9. The system according to claim 1, wherein said processor is further configured to:
queue all the endpoint machines assigned to the management system; and
execute a query on each of the queued endpoint machines, according to the queue, whether a current configuration of the endpoint machine and of a related management system is correct.

10. The system according to claim 1, wherein said processor is configured to perform at least some of the operations by at least one virtual agent applied to at least one endpoint machine, wherein the processor is further configured to perform at least one of a list comprising: deploying a virtual agent to an endpoint machine, replacing an old virtual agent with a new virtual agent, changing configuration of a virtual agent, removing a virtual agent, validating connectivity of a virtual agent to the management system, control resource consumption of a virtual agent, validation of general health and functionality of a virtual agent and validation of configuration of a virtual agent according to the correct rules.

11. A method comprising:
classifying, by a processor, one or more endpoint machines to one or more dynamic groups according to classification attributes of the endpoint machines;
assigning, by the processor, the dynamic group to a management system;
sending, by the processor, a management configuration to the management system, wherein the management system is adapted to manage endpoint machines included in the dynamic group based on the management configuration;
automatically detecting that an endpoint machine was added to a network;
deciding, according to a classification of the endpoint machine, which management system should be used for managing the endpoint machine; and
adding the endpoint machine to a dynamic group managed by the management system, wherein the management system is adapted to interact with the endpoint machine and to apply, to the endpoint machine, settings according to the management configuration.

12. The method according to claim 11, wherein the method further comprises at least one of: removing endpoint machines from the dynamic group and enabling communication between endpoint machines and management systems.

13. The method according to claim 11, wherein the endpoint machines are classified to dynamic groups according to classification attributes that indicate at least one of the role, functioning, relevance, grouping, attributes, metadata, time, location and status of the endpoint machines, wherein said processor is further configured to decide which management systems should be applied and how the applied management systems should be configured for each endpoint machine based on the classification.

14. The method according to claim 11, wherein the method further comprises detecting that an endpoint machine was added to dynamic group and applying to said added endpoint machine a rule related to said dynamic group of endpoint machines, and wherein the method further comprises detecting that an endpoint was removed from a dynamic group and cease applying the rule to said removed endpoint machine.

15. The method according to claim 11, wherein the method further comprises:
monitoring a configuration of an endpoint machine to verify that correct rules are applied; and
changing the configuration of the endpoint machine in case a configuration of the endpoint machine is not correct according to the rule.

16. The method according to claim 11, wherein the method further comprises executing rules, wherein a rule includes indication of to which dynamic group of endpoint machines the rule applies, the actions that should be taken when the rule applies and metadata about the rule.

17. The method according to claim 11, wherein the method further comprises executing by the adaptor at least one function of a list comprising: connecting to the management system, registering an endpoint machine to a management system, assigning a configuration to a management system, configure the communication channel between management system and endpoint, create a proxy channel between management system and endpoint, establish the identity of management system and endpoint machine, assigning a configuration to an endpoint machine, querying whether a current configuration of an endpoint machine is correct, querying the health of the management system, querying the health of an endpoint and deregistration of an endpoint machine from the management system.

18. The method according to claim 11, wherein the method further comprises building rules and improving existing rules based on information and analysis about machines, servers, tools, configurations and operations gathered from at least one of a list comprising endpoint machines, management systems, storage systems, processor operations and network devices or operations.

19. The method according to claim 11, wherein the method further comprises:
queuing all the endpoint machines assigned to the management system; and
executing a query on each of the queued endpoint machines, according to the queue, whether a current configuration of the endpoint machine and of a related management system is correct.

20. The method according to claim 11, wherein the method further comprises performing at least some of the operations by at least one virtual agent applied to at least one endpoint machine, wherein the method further comprises performing at least one of a list comprising: deploying a virtual agent to an endpoint machine, replacing an old virtual agent with a new virtual agent, changing configuration of a virtual agent, removing a virtual agent, validating connectivity of a virtual agent to a management system, control resource consumption of a virtual agent, validation of general health and functionality of a virtual agent and validation of configuration of a virtual agent according to the correct rules.
